(19) United States
(12) Patent Application Publication
(10) Pub. No.: US 2002/0056262 A1
(43) Pub. Date: May 16, 2002

(54) Harvesting machine with electrically driven material conveyor and/or material processing device

(76) Inventor: Serge Favache, Homburg (DE)

Correspondence Address: Kevin J. Moriarty, c/o Deere & Company, One John Deere Place, Moline, IL, 61265-8098, US

(21) Appl. No.: 09/908,363

(22) Filed: Jul. 18, 2001

(30) Foreign Application Priority Data
Jul. 18, 2000 (DE) 100 34 784.3

(51) Int. Cl. A01D 61/00

(52) U.S. Cl. 56/16.4 A

(57) ABSTRACT

An agricultural harvesting machine is provided with a material conveyor and a material processing device that are rotatively driven by electric motors. Both the material conveyor and the material processing device is provided with an interior. The electric motor driving the material conveyor and material processing device is located in its respective interior. The rotor of the electric motor is motively mounted to the material conveyor and the material processing device and rotates about a stationary stator comprising an axle of the respective device.

### FIELD OF THE INVENTION

The present invention is directed to a harvesting machine having a material conveyor and/or a material processing device, which is rotatively driven by an electric motor.

### BACKGROUND OF THE INVENTION

In the state of the art, material conveyor devices and material processing devices of agricultural harvesting machines are driven by a main motor via various means of mechanical power transmission, such as belts, shafts or cogwheels. In individual cases, e.g., intake rollers of field choppers, hydraulic drives are also used. Moreover, the space requirement for the various means of mechanical power transmission, their weight and their production costs must be viewed as disadvantageous.

Described in GB 1 593 698 A is a combination of a tractor with several attached mowing devices, in which each of the mowing blades of the mowing devices is driven by an electric motor. A generator aboard the tractor produces the electrical energy for the electric motors with a voltage of 400 V.

Disclosed in WO 94/24845 A is an automatic large baling press in which the elements of the baling device are driven by an electric motor.

Thus, it is fundamentally known that material processing devices of automatic harvesting machines can be driven by electric motors.

### SUMMARY

It is an object of the present invention to provide an improved material conveyor and/or material processing device for use on a harvesting machine.

The main feature of the present invention resides in the fact that the electric motor is located inside the material conveyor and/or material processing device. As such, the space required for the mechanical or hydraulic power transmission elements is saved, so that the harvesting machine can be designed more compact and lighter, or with a greater capacity or throughput for a given size. The electric motor is protectively housed in a previously unutilized cavity.

For driving the material conveyor and/or material processing device, it is proposed that an electric motor with a fixed stator and a rotary rotor be used, in which the stator is located inside the rotor. On the outer perimeter of the electric motor, a rotary movement is then provided which can be utilized for driving the material conveyor and/or material processing device of the harvesting machine.

The rotor can be especially rigid, i.e., directly coupled to the material conveyor and/or material processing device without engaging a transmission or other power transmission elements. Thus, power transmission elements are not needed. Nevertheless, in case the desired rotary speed of the material conveyor and/or material processing device varies greatly from the attainable rotary speed of the electric motor, a mechanical transmission in particular can be interposed between the rotor of the electric motor and the material conveyor and/or material processing device. For example, a planetary transmission may be interposed between the motor and the material conveyor and/or the material processing device, wherein the sun gear engages the rotor and the ring gear engages the material conveyor and/or material processing device. The planet gear carrier can engage the sun gear or be fixed as a function of the desired transmission ratio. A separate drive for the planet a gear carrier is also conceivable.

The stator of the electric motor can be mounted on an axle, which as a rule is secured on the frame of the harvesting machine. The axle can act as a bearing for the material conveyor and/or material processing device.

The electric motor can be a direct current (DC) motor or an alternating current motor (AC). If an AC motor is used it is desirable it would be a three-phase motor. The motor is preferably supplied with power by a generator that is driven by the main motor of the harvesting machine. When a DC motor is used, or when the electric motor is fed from the onboard system of the harvesting machine, an AC or a three-phase motor can be driven by means of a suitable converter.

The rotary speed or the torque of the electric motor is preferably variable and also preferably controllable. It is then possible to adapt without problem the rotary speed or the torque of the material conveyor and/or material processing device to the given harvesting conditions.

As already explained, a material conveyor and/or material processing device can be driven by the electric motor. A material processing device alters the nature of the crop material, i.e., it cuts, chops, threshes, separates, cleans, etc. For example a threshing cylinder and straw walkers may be driven by electric motors. In the case of an axially arranged rotary combine, the rotor can be driven by an electric motor. The cleaning fan of the cleaning system can also be driven by the electric motor. The chopping drum of a field chopper is also a material processing device that can be driven by an electric motor.

A material conveyor device serves to convey the crop material to different locations in the harvesting machine. Examples include oblique conveyors, routing and turning drums of combines, as well as feed rollers and blowers for conveying the chopped material in the case of field choppers.

### BRIEF DESCRIPTION OF THE DRAWINGS

FIG. 1 is a semi-schematic side view of a harvesting machine wherein the threshing cylinder is driven by an electric motor.

FIG. 2 is a cross sectional view of the threshing cylinder.

### DETAILED DESCRIPTION

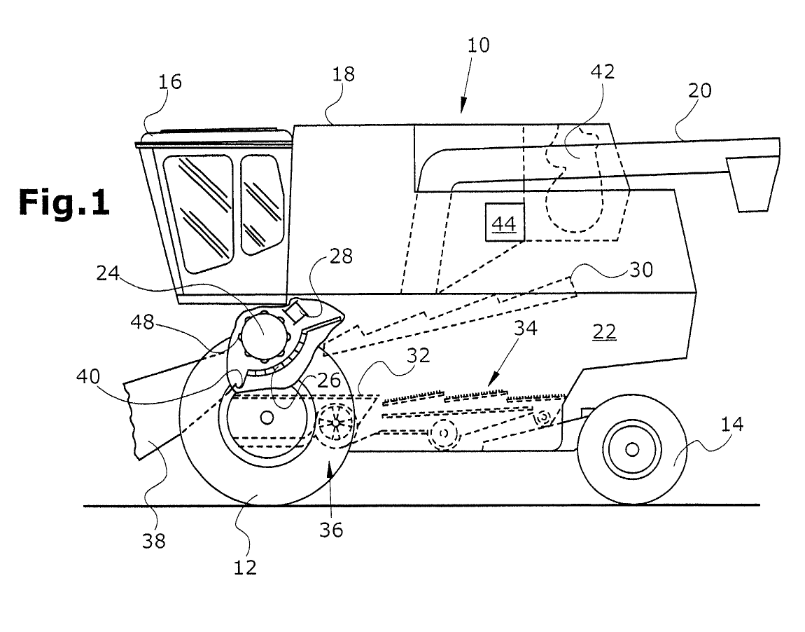

A harvesting machine 10 shown in FIG. 1 is an agricultural combine that is supported on front drive and rear steerable wheels 12 and 14, respectively. The operation of the combine is controlled from an operator's cab 16. A grain tank 18 is located behind the operator's cab 16 for temporarily storing harvest grain. An unloading auger 20 is used to unload the grain tank 18 in to a grain cart or truck. The grain tank 18 is mounted to a frame 22 formed by parallel sidesheets. Harvested crop material is conveyed through a feeder house 38 past a stone trap 40 to a threshing assembly. The threshing assembly comprises a rotating threshing cylinder 24, a stationary concave 26 and a rotating beater 28. The threshing cylinder 24 is provided with threshing elements 48 distributed over its periphery. The threshing assembly separates the harvested crop into its coarser and finer components. Grain and chaff falls from the concave onto grain pan 32. Straw walkers 30 are located downstream from the threshing assembly and comprise a separating assembly for releasing grain trapped in the large crop components. Released grain from the straw walkers is directed to grain pan 32 whereas the larger harvested components are thrown over the rear of the straw walkers and out the rear of the combine. The grain and chaff received by the grain pan 32 is directed to the sieves 34 of the cleaning system. The clean grain is directed by an elevator, not shown, to the grain tank 18. The light chaff is blown out the rear of the combine by cleaning fan 36.

The harvesting machine 10 has a main motor 42 that drives an electric generator 44. The main motor 42 is an internal combustion engine, typically a diesel engine. The generator 44 supplies electrical energy to electric motors located on the front driven wheels 12. It also supplies an electric motor 46 driving the threshing cylinder 24. The beater 28, the blower 36, the feeder house conveyor 38, the straw walkers 30 and the other material conveyor devices of the harvesting machine 10, can also be driven by electric motors.

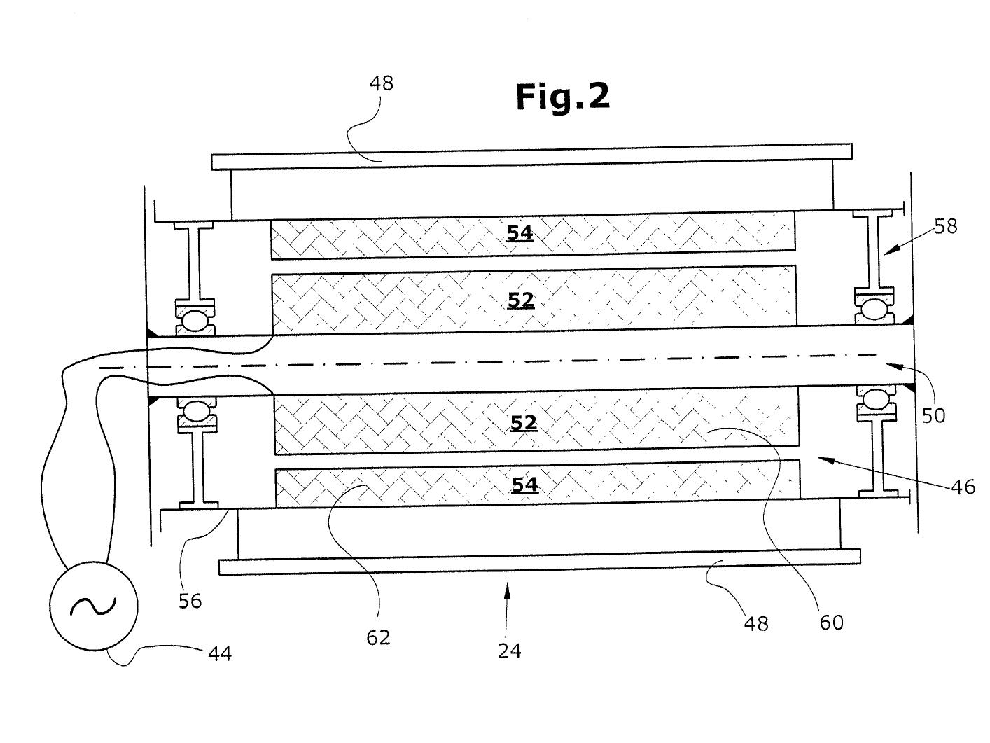

Illustrated in cross section in FIG. 2 is the thresher cylinder 24 with threshing elements 48 mounted externally thereon. Inside the thresher cylinder 24 is an electric motor 46. Electric motor 46 comprises a stationary stator 52 on an axle 50 and a rotary rotor 54. The stator 52 is situated inside the rotor 54. The rotor 54 is fastened on the inner side of the drum-shaped housing 56 of the thresher cylinder 24. The threshing elements 48 are externally mounted to the drum-shaped housing 56. The axle 50 is secured to the frame 22 of the harvesting machine 10. The side walls 58 of the drum-shaped housing 56 of the threshing cylinder 24 are borne on the axle 50 by ball bearings.

The stator 52 and the rotor 54 have wire windings 60, 62, respectively, that are electrically connected to the generator 44. The wire windings of the rotor 54 are connected to the generator 44 by way of frictional contacts on the axle 50. The wire windings 60, 62, through which current flows, generates magnetic fields via which the rotor 54 is set into motion, rotating the threshing cylinder 24 and thereby threshing the crop material. A power control is located between the generator 44 and the electric motor 46, which is used to adjust the rotary speed of the motor.

Having described the preferred embodiment, it will become apparent that various modifications can be made without departing from the scope of the invention as defined in the accompanying claims.

1. A harvesting machine with a material processing device which is driven by an electric motor, the material processing device having an outer perimeter that is provided with a crop processing device, the crop processing device also having an interior, characterized in that the electric motor is located in the interior of the material processing device.

2. A harvesting machine as defined by claim 1, wherein the electric motor has a stator, which is located inside a rotary rotor, and that the rotor is motively connected to the material processing device.

3. A harvesting machine as defined by claim 2, wherein the rotor is directly connected to the material processing device.

4. A harvesting machine as defined by claim 3, wherein the material processing device is mounted on an axle of the stator.

5. A harvesting machine as defined by claim 4, wherein the harvesting machine is provided with a main motor that drives a generator for supplying electric power to the electric motor.

6. A harvesting machine as defined by claim 5 wherein the electric motor is a DC motor.

7. A harvesting machine as defined by claim 5 wherein the electric motor is a three-phase AC motor.

8. A harvesting machine as defined by claim 5 wherein the rotary speed of the electric motor is adjustable.

9. A harvesting machine as defined by claim 5 wherein the material processing device is a threshing cylinder.

10. A harvesting machine with a material conveyor which is driven by an electric motor, the material conveyor having an interior, characterized in that the electric motor is located in the interior of the material conveyor.

11. A harvesting machine as defined by claim 10, wherein the electric motor has a stator, which is located inside a rotary rotor, and that the rotor is motively connected to the material conveyor.

12. A harvesting machine as defined by claim 11, wherein the rotor is directly connected to the material conveyor.

13. A harvesting machine as defined by claim 12, wherein the material conveyor is mounted on an axle of the stator.

14. A harvesting machine as defined by claim 13, wherein the harvesting machine is provided with a main motor that drives a generator for supplying electric power to the electric motor.

15. A harvesting machine as defined by claim 14 wherein the electric motor is a DC motor.

16. A harvesting machine as defined by claim 14 wherein the electric motor is a three-phase AC motor.

17. A harvesting machine as defined by claim 14 wherein the rotary speed of the electric motor is adjustable.
